(19) United States
(12) Patent Application Publication
(10) Pub. No.: US 2007/0131061 A1
(43) Pub. Date: Jun. 14, 2007

(54) HANDLE FOR HAMMER

(76) Inventor: Yung-Shou Chen, Taichung County (TW)

Correspondence Address: PAI PATENT & TRADEMARK LAW FIRM, 1001 FOURTH AVENUE, SUITE 3200, SEATTLE, WA, 98154, US

(21) Appl. No.: 11/164,983

(22) Filed: Dec. 13, 2005

(51) Int. Cl. B25D 1/00

(52) U.S. Cl. 81/20

(57) ABSTRACT

An orthopedically engineered handle for hammer is disclosed, which comprises a substantially straight front handle body section, a front coupling tip straightly forwardly extending from the front end of the front handle body section, and a double-curved rear handle body section backwardly extending from the rear end of the front handle body section and smoothly curving upwards at a climbing angle about 5°˜7° and then smoothly curving downwards at a descending angle about 5°˜7°.

### BACKGROUND OF THE INVENTION

(a) Field of the Invention

The present invention relates to a hammer and more particularly to a handle for hammer that is orthopedically engineered for comfortable use with a high performance.

(b) Description of the Prior Art

A conventional hammer comprises a handle for grasping by the user, and a metal head fixedly fastened to one end of the handle. Normally, the handle is made of a wooden material. There is known a hammer having a metal handle capped with an anti-slip grip. The handles of conventional hammers may have a different thickness and/or cross section. However, these handles commonly have a straight center axis.

According to tests, a straight handle for hammer is not an orthopedically engineered design. Lifting the hammer or moving the hammer downward to strike the workpiece stretches the muscles of the arm, forearm, elbow and wrist. An ordinary person who uses a hammer may rarely use the wrist joint as the center of axis to support the movement of the hand. A skilled person usually uses the elbow and the shoulder joint to support the movement of the forearm and the hand when operating the hammer. Lowering the stretching action of the extensor carpi ulnaris muscle of the forearm and increasing the stretching action of the triceps brachii muscle of the upper arm improve the hammering performance and comfort the hammering operation.

### SUMMARY OF THE INVENTION

The present invention has been accomplished under the circumstances in view. It is the main object of the present invention to provide a handle for hammer, which is orthopedically engineered, having a double-curved rear handle body section that effectively lowers the stretching action of the extensor carpi ulnaris muscle of the forearm and increases the stretching action of the triceps brachii muscle of the upper arm when it is operated by the user, thereby improving the hammering performance and comforting the hammering operation.

According to one aspect of the present invention, the orthopedically engineered handle has a substantially straight front handle body section, a front coupling tip straightly forwardly extending from the front end of the front handle body section, and a double-curved rear handle body section backwardly extending from the rear end of the front handle body section and smoothly curving upwards at a climbing angle about 5°˜7°, and then smoothly curving downwards at a descending angle about 5°˜7°. Most preferably, the climbing angle is 6°, and the descending angle is 6°.

According to another aspect of the present invention, the rear part of the double-curved rear handle body section has a bottom edge curving initially downwards at a predetermined angle and then curving downwards to at a relatively greater angle.

### BRIEF DESCRIPTION OF THE DRAWINGS

FIG. 1 is a schematic side plan view of a handle for hammer according to the present invention.

FIG. 2 is a schematic top plan view of the handle for hammer according to the present invention.

FIGS. 3a˜3e are sectional views on different parts of the handle for hammer according to the present invention.

FIG. 4 is a schematic front plan view of the handle for hammer according to the present invention.

FIG. 5 is a schematic rear view of the handle for hammer according to the present invention.

FIG. 6 is a schematic drawing showing the handle fastened to a hammerhead according to the present invention.

FIG. 7 is a schematic drawing explaining the structural design of the present invention.

### DETAILED DESCRIPTION OF THE PREFERRED EMBODIMENTS

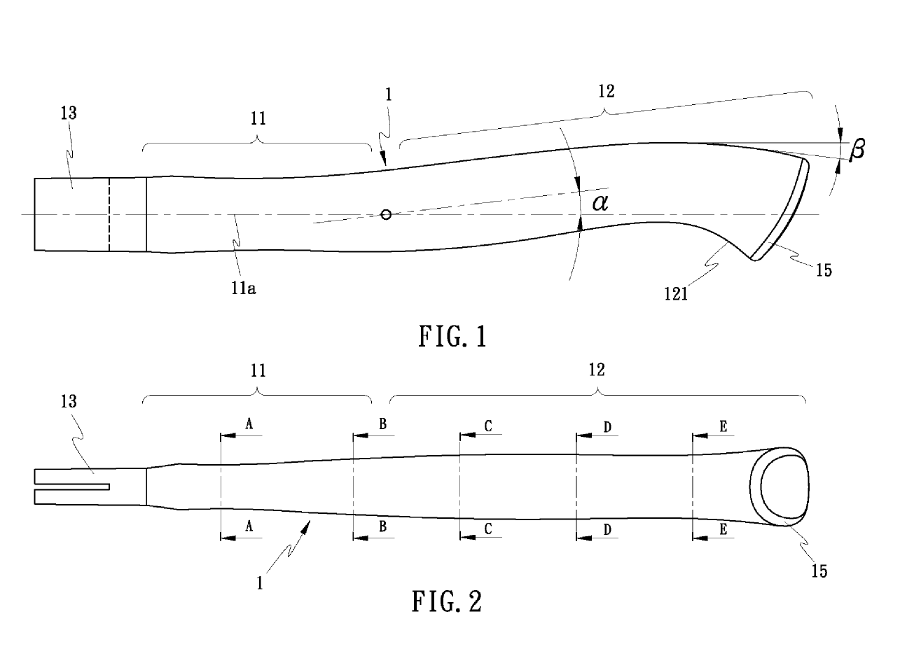

Referring to FIG. 1, a handle 1 in accordance with the present invention is shown having a substantially straight front handle body section 11, a front coupling tip 13 forwardly extending from the front end of the front handle body section 11 and axially aligned with the handle body section 11 in a straight line, and a double-curved rear handle body section 12 backwardly extending from the rear end of the front handle body section 11. The double-curved rear handle body section 12 curves upwards and then downwards relative to the longitudinal central axis 11a of the front handle body section 11 when extending backwards from the rear end of the front handle body section 11. The downwards/upwards curvature of the double-curved rear handle body section 11 is set within 5°˜7°, i.e., the double-curved rear handle body section 11 is smoothly curving upwards at a climbing angle α about 5°˜7° (the bottom side can be curving upwards at a climbing angle about 9°) and then curving downwards at a descending angle β about 5°˜7°. This double-curved design is an orthopedically engineered design that lowers the stretching action of the extensor carpi ulnaris muscle of the forearm and increasing the stretching action of the triceps brachii muscle of the upper arm, and therefore the user can operate the hammer efficiently and comfortably with less effort, i.e., a hammer with this structure of handle is suitable for professional persons.

According to tests, an ordinary person applies much effort to the hammer through the extensor carpi ulnaris muscle of the forearm, and a skilled person applies much effort to the hammer through the triceps brachii muscle of the upper arm. According to a calculation on hammering efficiency, an ordinary person needs to strike the hammer against the nail for 10.6 times before driving the nail completely into wood, and a skilled person can drive the nail into wood simply by striking the hammer against the nail for 4.9 times. Therefore, lowering the stretching action of the extensor carpi ulnaris muscle of the forearm comforts the hammering action, and an ordinary user becomes skillful soon when increasing the stretching action of the triceps brachii muscle of the upper arm.

Further, tests showed that the best climbing angle α or descending angle β of the double-curved rear handle body section 12 is at about 6°.

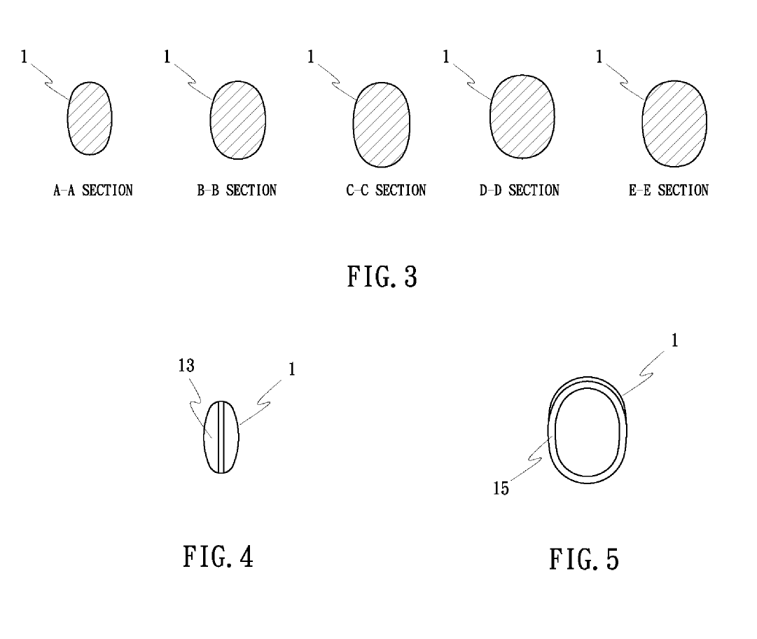

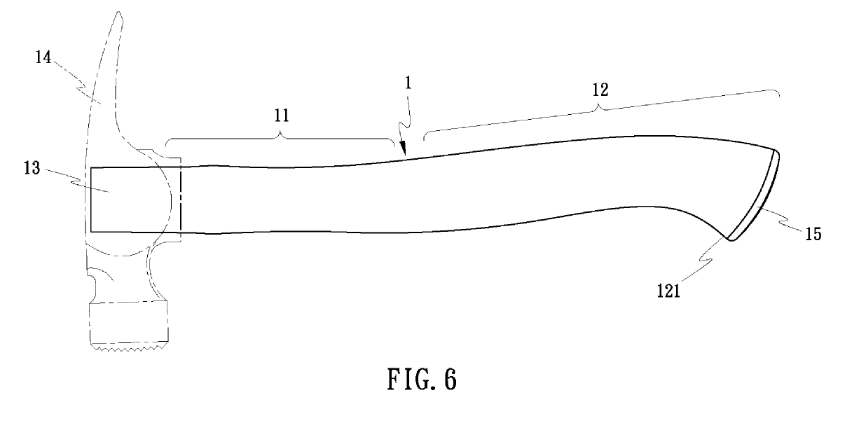

FIGS. 3a˜3e are cross-sectional views on different parts of the substantially straight front handle body section 11 and the double-curved rear handle body section 12 of the handle 1 according to the present invention. As indicated, the handle 1 has different dimensions at different locations. FIG. 4 and FIG. 5 are schematic front and rear views of the handle 1. Further, the front coupling tip 13 is adapted for fastening the handle 1 to a hammerhead 14 (see FIG. 6).

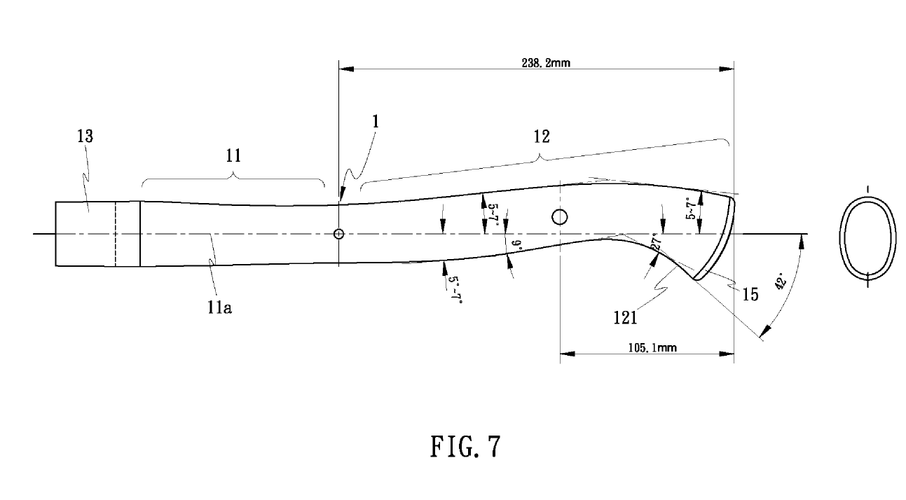

Referring to FIG. 7, the double-curved rear handle body section 11 is curving upwards at a climbing angle α about 5°˜7°, and then curving downwards at a descending angle β about 5°˜7°. Further, the bottom edge 121 of the rear part of the double-curved handle body section 12 curves initially downwards at 27° and then keeps curving downwards to the maximum angle of 42° for tight gripping and convenient manipulation by hand.

Further, the double-curved rear handle body section 12 has the free end terminating in a chamfered annular end edge 15. The chamfered annular end edge 15 is smooth and does not hurt when touched by hand. Further, an anti-slip rubber grip (not shown) may be capped on the double-curved rear handle body section 12 of the handle 1.

A prototype of handle for hammer has been constructed with the features of FIGS. 1˜7. The handle for hammer functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A handle for hammer, comprising:
a substantially straight front handle body section;
a front coupling tip forwardly extending from a front end of said front handle body section and axially aligned with said front handle body section in a straight line; and
a double-curved rear handle body section backwardly extending from a rear end of said front handle body section opposite to said front coupling tip,
wherein a top edge of said double-curved rear handle body section forms an upper contour curve which, starting from said rear end of the front handle body section, curves upwards smoothly at an increasingly positive slope until the slope reaches a first preset maximum angle, then at a decreasing slope until the slope is back to zero, and then continues to curve downwards smoothly at an increasingly negative slope until the slope reaches a first preset ending angle.

2. The handle for hammer as claimed in claim 1, wherein the first preset maximum angle is from 5° to 7°.

3. The handle for hammer as claimed in claim 1, wherein the first preset ending angle is steeper than 7°.

4. The handle for hammer as claimed in claim 1, wherein the first preset maximum angle is about 6°.

5. The handle for hammer as claimed in claim 1, wherein said front handle body section and said double-curved rear handle body section have different dimensions at different locations.

6. The handle for hammer as claimed in claim 1, wherein said double-curved rear handle body section has a bottom edge of a rear part thereof curving initially downwards at 27° and then curving downwards to a maximum angle of 42°.

7. The handle for hammer as claimed in claim 1, wherein a bottom edge of said double-curved rear handle body section forms a lower contour curve which, starting from said rear end of the front handle body section, curves upwards smoothly at an increasingly positive slope until the slope reaches a second preset maximum angle, then at a decreasing slope until the slope is back to zero, and then continues to curve downwards smoothly at an increasingly negative slope until the slope reaches a second preset ending angle.

8. The handle for hammer as claimed in claim 7, wherein the first preset maximum angle is 5°˜7°and the second preset maximum angle is about 9°.
